(19) United States
(12) Patent Application Publication
(10) Pub. No.: US 2025/0017691 A1
(43) Pub. Date: Jan. 16, 2025

(54) PALATAL ANCHORAGE DEVICE FOR ORTHODONTIC TREATMENT WITH ENHANCED SUPPORT AND METHOD MANUFACTURING PALATAL ANCHORAGE DEVICE

(71) Applicant: Hung Kuo CHOU, Seoul (KR)

(72) Inventor: Hung Kuo CHOU, Seoul (KR)

(21) Appl. No.: 18/767,874

(22) Filed: Jul. 9, 2024

(30) Foreign Application Priority Data
Jul. 12, 2023 (KR) 10-2023-0090131

(51) Int. Cl. A61C 7/00; A61C 9/00; B33Y 50/02; B33Y 80/00

(52) U.S. Cl. CPC A61C 7/00; A61C 9/0053; B33Y 50/02; B33Y 80/00

(57) ABSTRACT

A palatal anchorage device for orthodontic treatment with enhanced support is provided, which includes a body having a form of a triangular truss, screw fixation parts formed on each of three vertex regions of the body, with through-holes formed therein to allow a screw to be placed in a palate, and hook parts extending from both sides of the body and hooking and fixing an elastic body connected to a tooth fixture.

### RELATED CROSS-REFERENCE TO APPLICATION

This application claims priority to Korean Patent Applications No. 10-2023-0090131, filed in the Korean Intellectual Property Office on Jul. 12, 2023, the entire contents of which are hereby incorporated by reference.

### BACKGROUND

### Technical Field

The present disclosure relates to a palatal anchorage device for orthodontic treatment, which is fixed on the palate to support an elastic body connected to a tooth fixture for orthodontic treatment, and, more particularly, to a palatal anchorage device for orthodontic treatment with enhanced support, which includes a body formed of a triangular truss structure to enhance support against pulling by the elastic body to improve orthodontic effectiveness, and to a method for producing the palatal anchorage device.

### Description of Related Art

In general, orthodontic treatment with the orthodontic part moved backward for the treatment of second-class malocclusion patients may use an extraoral device such as a head gear, but an intraoral device that requires less patient cooperation may be preferred.

Meanwhile, the existing intraoral device may have side effects of extrusion of maxillary posterior teeth and anterior tilt of anterior teeth, and constant research has been conducted on the intraoral devices that can stably move teeth in the maxillary posterior region.

In recent years, mini-implants as a skeletal anchorage source have become more common, and palatal devices have been developed that use the mini implants to move the maxillary molars backward, minimizing the side effects and effectively moving the teeth.

The commonly used mini-implants are placed on both sides of the alveolar bone, with an elastic body connected to the molars and the mini-implants to apply external forces to the molars. In general, mini implants must be placed in the alveolar bone area in line with the teeth for solid fixation, so the tooth roots may be damaged during the procedure, and it is also difficult to accurately position the mini implants.

To solve these problems, MCPP non-extraction orthodontic surgery using a palatal anchorage device for orthodontic treatment (modified C-palatal plate (MCPP)) has been proposed, which pierces the mucous membrane with a fixing screw and is fixed to the palate.

This type of non-extractive orthodontic treatment with a palatal appliance has several advantages.

First, it eliminates the risk of root damage that can occur with interproximal mini-implant placement. In addition, when moving teeth using a mini implant between tooth roots, there is a possibility of tooth root resorption or the mini implant falling out when the mini implant touches the tooth root, but there is no such risk with the palatal device.

Second, because the device is not implanted in the alveolar bone, there is a low probability of damage to the permanent teeth underneath the deciduous teeth, so it can also be applied to patients in the mixed dentition stage.

Third, orthodontic treatment with palatal appliances does not apply force between teeth, which prevents unnecessary tooth movement. In addition, because the palate device is placed in the non-tooth bearing area, it is possible to move as many teeth as possible on the desired side, making it easy to plan and design tooth movement.

Fourth, the palate device enables the same effect as the head gear and is relatively free from patient cooperation because it is located intraorally.

Fifth, since the palate device enables a significant amount of tooth movement, non-surgical orthodontic treatment may be possible even in patients who need to consider corrective surgery due to severe skeletal dissonance.

Such a palatal anchorage device for orthodontic treatment for non-extraction orthodontics are disclosed in Korean Registered Patents Nos. 10-1083280, 10-2263929, 10-1646905, 10-2263933, and 10-1314315.

For example, the non-extractive orthodontics using these related palatal anchorage device for orthodontic treatment involves mounting a tooth fixture to surround the molar teeth, connecting the tooth fixture using a U-shaped wire, fixing a palatal anchorage device to the palate using a screw, and then connecting the hook of the wire and the palatal anchorage device with an elastic body such as a spring or rubber band so that the entire maxillary teeth are moved backward for correction by the elastic force of the elastic body.

The palatal anchorage device for orthodontic treatment disclosed in Korean Registered Patent Nos. 10-1083280, 10-2263929, 10-1646905, 10-2263933, and 10-1314315 includes: a body portion including an arc-shaped body and support member wing parts extending from left and right sides of the body; a hook part formed in back of the support member wing parts of the body portion, and including a locking part into which an elastic body connected to an orthodontic device is fitted and coupled; and a leg part with a front leg part and a rear leg part protruding from the front and rear sides of the body of the body portion respectively for the insertion of the screw in the palate.

Meanwhile, the related palatal anchorage device for orthodontic treatment is configured such that it includes ribs extending from the front and rear sides of the body portion, respectively, and a screw fixation part having a through hole for installing a screw at the ends of the ribs, and the related palatal anchorage device for orthodontic treatment with the above configuration has a problem that the palatal anchorage device cannot properly support against the pulling force of the elastic body.

In other words, the related palatal anchorage device for orthodontic treatment includes ribs extending radially from the middle of the body formed in the form of branches, with the screw fixation parts formed at the ends of the ribs, and wing parts extending from the left and right sides of the body to support the elastic body. Accordingly, the related palatal anchorage device in such a form can not provide a sufficient support force for supporting the elastic body.

In addition, since the related palatal anchorage device for orthodontic treatment includes a body elongated on the left and right, and wings extending from the body to the left and right, and has a complex branch structure with ribs extending from the body to the front and back.

Accordingly, the structure is complicated and bulky, and the weight increases, making it uncomfortable to consume and swallow food, or maintain clean mouth. Additionally, because many parts of the device contact the tongue, there is a problem in that adults as well as teenagers feel uncomfortable with pronunciation.

In addition, most of the related palatal anchorage device for orthodontic treatment includes various metal mixtures of low-cost non-precious metals, which are heavy in weight and are produced by casting through complicated produce process. Further, even after casting, it is very difficult to precisely set the palatal appliance to fit the individual's palate because the clinician has to bend by hand the body or wing parts to fit the individual's palate, which is time-consuming, and the degree of bending is also determined by the human eye.

### SUMMARY

In order to solve one or more problems (e.g., the problems described above and/or other problems not explicitly described herein), the present disclosure provides a palatal anchorage device for orthodontic treatment with improved support, which includes a body with a triangular truss structure so as to provide a good fixing retention by implant placement and reduce the failure rate of implant placement, and which has a strengthened supporting force against pulling of the elastic body so as to enhance the correction effect.

The present disclosure also provides a palatal anchorage device for orthodontic treatment having an improved shape, which is compactly configured with reduced volume and size, thereby reducing the patient's rejection of the procedure and improving convenience of the procedure.

Furthermore, the present disclosure also provides a method for producing a palatal anchorage device that is easy to design and produce according to various palatal sizes of growing adolescents, in which the method can significantly shorten the procedure time by reducing the process and time of production by utilizing a 3D printer.

It should be understood, however, that the scope of the present disclosure is not limited to the above and that the objects and effects which can be understood from the solution means and the embodiments of the present disclosure are also included therein even if not explicitly mentioned.

According to some aspects, a supportive palatal anchorage device for orthodontic treatment is provided, which may include a body having a form of a triangular truss, screw fixation parts formed on each of three vertex regions of the body, with through-holes formed therein to allow a screw to be placed in a palate, and hook parts 120 extending from both sides of the body and hooking and fixing an elastic body connected to a tooth fixture.

The body may be in the form of an isosceles triangle.

The screw fixation parts may include a front screw fixation part formed on a front vertex of the body, and a pair of rear screw fixation parts formed on both rear vertices of the body, and the pair of rear screw fixation parts may be configured to be left-right symmetrical with respect to the front screw fixation part.

The hook part may be configured to extend on both sides from both vertices at a rear end of the body.

The body may have a form of an isosceles triangle, in which the isosceles triangle may have a length of a base of the isosceles triangle less than a height.

A method for producing a palatal anchorage device is provided, which may include scanning a dental arch of a patient's teeth and acquiring an image of the arch, Editing a reference palatal anchorage device model based on the arch image a patient-customized palatal anchorage device model, and printing the patient-customized palatal anchorage device model with a 3D printer and producing a patient-customized palatal anchorage device.

According to the aspects of the disclosure, the palatal anchorage device for orthodontic treatment provides an advantageous effect in that the body of the palatal anchorage device has a triangular truss structure that strengthens the supporting force of the elastic body compared to the existing devices, to thereby enhance the correction effect and increase the success rate of implant placement due to good fixed retention, resulting in more effective orthodontic treatment.

In particular, the present disclosure provides an advantageous effect in that, compared to the existing palatal anchorage devices, the size of the total length of the palatal anchorage device is reduced by more than 30%, thus reducing foreign body sensation, lightening the overall weight, and causing relatively small areas of contact with the tongue, thus less affecting the pronunciation, and food intake and swallowing process. Accordingly, patients are less reluctant to the orthodontic procedures and can undergo correction comfortably without discomfort, and from the clinician's point of view, the convenience of the procedure is also greatly improved thereby greatly shortening the procedure time.

In addition, the aspects of the disclosure will be able to present a groundbreaking and new paradigm for orthodontic treatment, because by the process of scanning the oral cavity and producing the device based on this scan information by the 3D printing techniques with bio-friendly materials such as medical synthetic resin or medical titanium, compared to the existing palatal anchorage devices, it is very easy to design and produce the device, and additionally, the process and time of production can be saved, allowing the device to be produced and planted on the same day at the dentist.

Further, the various and beneficial advantages and effects of the present disclosure are not limited to the above description, and can be more easily understood in the course of describing a specific embodiment of the present disclosure.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a perspective view of a palatal anchorage device for orthodontic treatment;

FIG. 2 is a front view illustrating a palatal anchorage device for orthodontic treatment;

FIG. 3 is a side view illustrating a palatal anchorage device for orthodontic treatment;

FIG. 4 is a top view illustrating a palatal anchorage device for orthodontic treatment;

FIG. 5 illustrates a palatal anchorage device for orthodontic treatment in use;

FIG. 6 shows photographs of a palatal anchorage device for orthodontic treatment according to an aspect of the disclosure and a related MCPP palatal appliance for comparison;

FIG. 7 illustrates a system for producing a palatal anchorage device for orthodontic treatment;

FIG. 8 illustrates a method for producing a palatal anchorage device for orthodontic treatment; and

FIGS. 9 and 10 illustrate examples of reference models according to an aspect of the present disclosure.

### DETAILED DESCRIPTION

The above and other objects, features and advantages of the present invention will be easily understood through the following preferred embodiments in conjunction with accompanying drawings. However, the present invention is not limited to the embodiments described herein and may be embodied in other forms. Rather, the embodiments introduced herein are provided so that the disclosed content can be thorough and complete, and the technical idea of the present invention can be sufficiently conveyed to those skilled in the art.

In the description, when one component is described as being on another component, it means that the component may be directly formed on the other component or a third component may be interposed therebetween. Further, in the drawings, thicknesses of the components are exaggerated for effective description of the technical content.

Embodiments described herein will be explained with reference to cross-sectional views and/or plan views, which are ideal illustrative views of the present invention. In the drawings, thicknesses of films and regions are exaggerated for effective description of the technical content. Accordingly, the form of the illustrative drawings may be modified in consideration of manufacturing technology and/or tolerance. Accordingly, embodiments of the present invention are not limited to the specific forms illustrated, and may also include changes in form that may be generated according to the producing process. For example, an etched region illustrated at right angles may be rounded or formed in a shape having a predetermined curvature. Accordingly, the regions illustrated in the drawings have properties, and the shapes of the regions illustrated in the drawings are intended to illustrate specific shapes of regions of the device and not to limit the scope of the invention. In various embodiments of the present description, terms such as first, second, and so on are used to describe various components, but these components should not be limited by these terms. These terms are merely used for the purposes of distinguishing one component from another. The embodiments described and illustrated herein also include complementary embodiments thereof.

The terms used herein is for the purposes of describing the embodiments, and are not intended to limit the present invention. In the description, a singular expression also includes a plural expression unless specifically stated otherwise in the context. As used herein, the terms ‘comprises’ and/or ‘comprising’ indicate that the mentioned component does not exclude the presence or addition of one or more other components.

In describing the specific embodiments below, various particular contents have been prepared to more specifically describe the invention and help understanding. However, a reader with sufficient knowledge in the art to understand the present disclosure will recognize that it may be used without these various particular contents. It should be mentioned in advance that, in some cases, in describing the invention, parts that are commonly known and not largely related to the invention are not described in order to avoid confusion in describing the present invention and for no other reason.

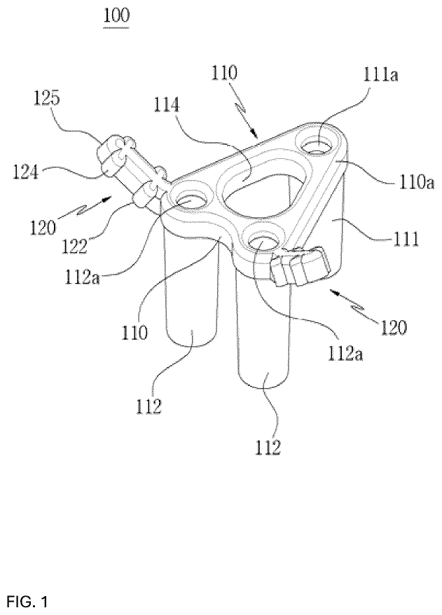

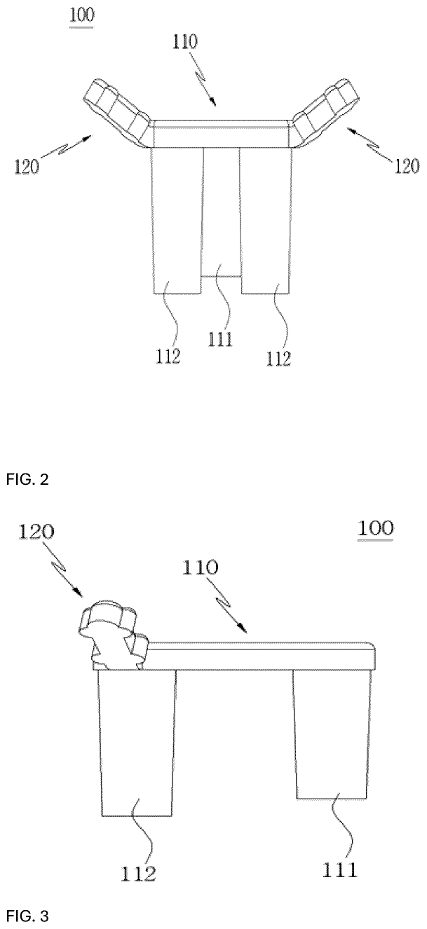

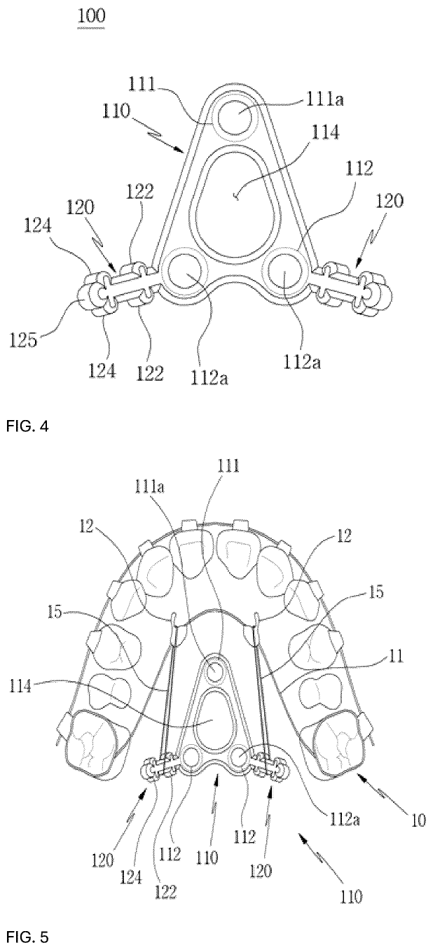

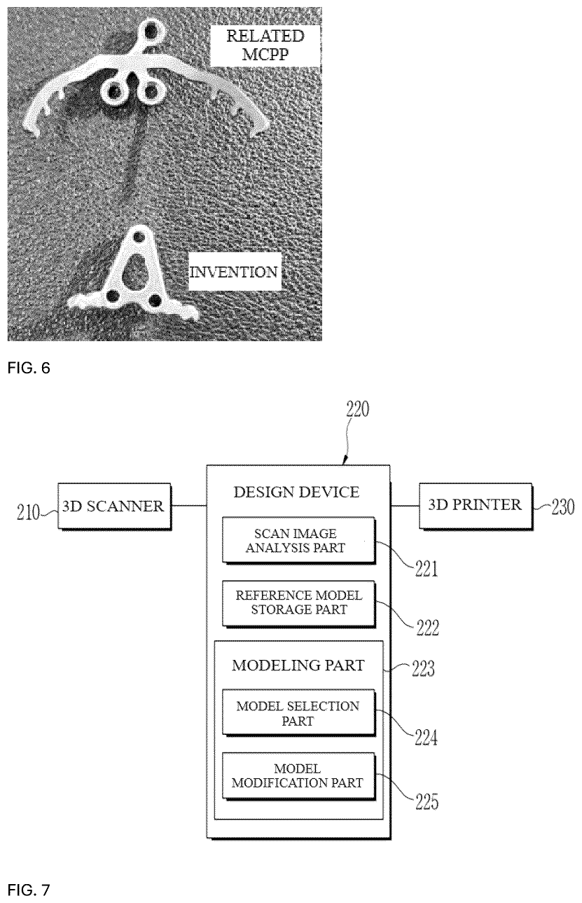

A palatal anchorage device 100 for orthodontic treatment with enhanced support will be described with reference to FIGS. 1 to 6.

The palatal anchorage device 100 for orthodontic treatment according to some aspects has been developed in a completely new design by improving the related palatal anchorage device for orthodontic treatment, and is named a Novel Palatal Anchorage Device (NPAD).

The palatal anchorage device 100 for orthodontic treatment according to some aspects includes a body 110, screw fixation parts 111, 112, and a hook part 120.

The body 110 has a triangular truss structure having a hollow portion 114 in the center, and includes the screw fixation parts 111, 112 having through holes 111a, 112a formed at the triangular vertex regions for planting a screw in the palate to fixedly couple the body 110 to the palate.

The screw fixation parts 111, 112 may include a front screw fixation part 111 configured at an anterior end of the body 110 and a pair of rear screw fixation parts 112 configured at both vertices at a rear end of the body 110.

The hook parts 120 extend and protrude from both sides of the body 110 and is configured to be connected by a hook 12 of a wire 11 connecting the tooth retainer 10 and an elastic body 15, as shown in FIG. 5.

In the present disclosure, the body 110 is configured as a triangular truss structure, so that when the screw fixation parts 111, 112 are fixedly installed on the palatine bone of the patient with screws, the fixation retention force can be improved to increase the success rate of the placement of the palatal anchorage device, and when the elastic body 15 is connected to the hook parts 120 formed on both sides of the body 110 of the triangular truss structure, the support force against the pulling of the elastic body 15 can be improved.

In particular, in the present disclosure, the triangular truss structure of the body 110 may be configured in the form of an isosceles triangle, and a pair of rear screw fixation parts 112 are configured symmetrically on both sides with respect to the front screw fixation part 111. Therefore, when the elastic body 15 is hung on the hook parts 120 formed on both sides of the body 110, the backward movement of the maxillary dentition can proceed evenly and without eccentricity because the direction of the pulling force of the elastic body acts equally on the hook parts 120 on both sides.

Furthermore, in the present disclosure, the hook parts 120 may extend laterally from a side of the body 110 having the isosceles triangular truss structure, or more specifically, from both vertices on a rear side of the isosceles triangle. Accordingly, the support force of the palatal anchorage device 100 against the pulling of the elastic body 15 can be further improved because the front screw fixation part 111, which is formed a predetermined distance forward from the midpoint between the rear screw fixation part 112 on both sides, supports the rear screw fixation part 112 so that the rear screw fixation part 112 does not move forward even when a force is generated to move the rear screw fixation part 112 forward by the pulling force of the elastic body 15.

Further, according to some aspects, the body 110 has an isosceles triangular truss structure, but is configured such that the base of the isosceles triangle is smaller than the height. The spacing (the base of the isosceles triangle) between the pair of rear screw fixation parts 112 may be shorter than the shortest straight-line distance (the height of the isosceles triangle) from the pair of rear screw fixation parts 112 to the front screw fixation part 111, so that the overall side-to-side length of the palatal anchorage device 110 can be reduced and the product can be compact sized. In addition, the shortest straight-line distance (the height of the isosceles triangle) from the pair of rear screw fixation parts 112 to the front screw fixation parts 111 is relatively longer than the spacing (the base of the isosceles triangle) between the pair of rear screw fixation parts 112, so that the force that fixes and supports the body 110 can be improved.

On the other hand, the hook part 120 may include a plurality of locking protrusions 122, 124 at predetermined intervals to be locked with the elastic body 15 and fix the elastic body 15 in position, and may further include a rounded portion 125 on an end of the hook part 120 to prevent the elastic body 15 from being caught at the end of the hook part 120 when the elastic body 15 is unhooked from the locking protrusions 122, 124 to facilitate easy release of the elastic body.

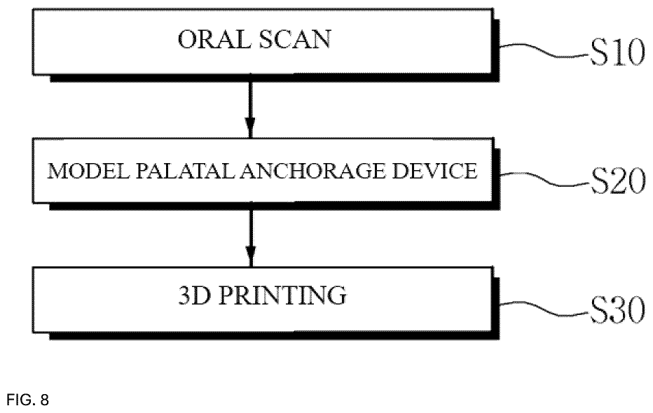

Hereinafter, a system and a method for producing a palatal anchorage device for orthodontic treatment by 3D printing will be described with reference to FIGS. 7 to 10.

The method for producing the palatal anchorage device for orthodontic treatment may be performed by a palatal anchorage device system including a 3D oral scanner 210, a design device 220, and a 3D printer 230.

The producing may involve scanning the palatal arch of a patient's teeth with the 3D oral scanner 210 and acquiring a palatal arch image at S10, modifying and resizing a previously designed reference palatal anchorage device model using the design device 220 to fit the shape and size of each patient's palatal arch and completing a patient-customized palatal anchorage device model at S20, and printing the patient-customized palatal anchorage device model with the 3D printer 230 at S30.

The design device 220 may include a computer for modeling and creating, editing, modifying, etc. the palatal anchorage device model, and may include hardware or software, or an integration of hardware and software.

The design device 220 may be configured to include a general personal computer such as a desktop or a laptop, as well as mobile terminals such as smartphones, tablet PCs, personal digital assistants (PDAs), and mobile communication terminals, and may also be installed on any device that is capable of computing and interpreted as the device capable of computing. The system may include a program (software) installed on any such device capable of computing to model a palatal anchorage device and generate a modeling file for 3D printing.

The design device 220 may be configured to modify and resize the reference palatal anchorage device model to fit the respective patient maxillary arch shape and size based on the previously designed reference palatal anchorage device model and complete a patient-customized palatal anchorage device model.

The design device 220 may be configured to receive a 3D maxillary arch image scanned by the 3D oral scanner 210 and display the image on a screen, and may include an editing tool with which an operator may edit the previously designed reference palatal anchorage device model into a patient-customized palatal anchorage device model by modifying the reference palatal anchorage device model to fit the shape and size of the 3D maxillary arch image. The patient-customized palatal anchorage device model produced with the editing tool as described above may be transmitted to the 3D printer 230, and the palatal anchorage device for orthodontic treatment may be produced by 3D printing via the 3D printer 230.

In this way, it is possible to scan a patient's dental maxilla with a 3D oral scanner, and modify and resize the previously designed reference model to fit each patient's maxilla shape and size and produce the device by medical 3D printing. Accordingly, same-day surgical treatment is possible, which can greatly improve convenience and practicality.

According to some aspects, the design device 220 may include a scan image analysis part 221, a reference model storage part 222, and a modeling part 223.

The scan image analysis part 221 may be configured to receive a 3D maxillary arch image of the patient's dental maxillary arch from the 3D oral scanner 210, and detect palatal information including a left-to-right flexion of the patient's palatal arch and a right-to-left flexion of the patient's palatal arch through image analysis based on the 3D maxillary arch image.

The reference model storage part 222 is configured to store and manage reference palatal anchorage device models. The stored reference palatal anchorage device models may include reference palatal anchorage device models for each angle of the hook part 120, including predetermined upward and downward tilt angles, and predetermined forward and backward tilt angles of the hook part 120 relative to the body 110.

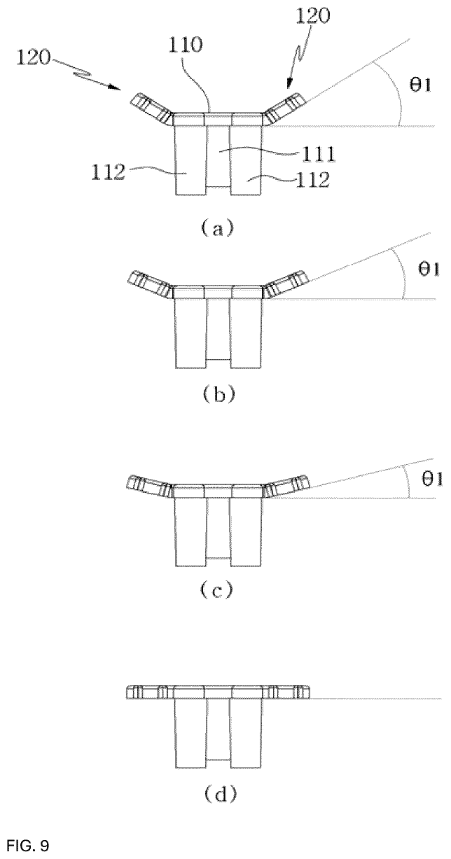

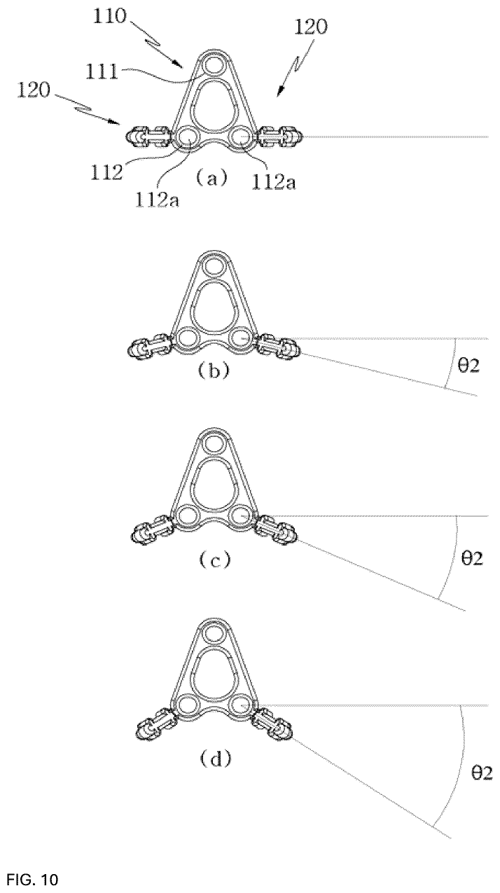

For example, the stored reference palatal anchorage device model may include a plurality of reference palatal anchorage device models with varying upward and downward tilt angles θ1 of the hook part 120 relative to the body 110, as shown in FIG. 9, and a plurality of reference palatal anchorage device models with varying forward and backward tilt angles θ2 of the hook part 120 relative to the body 110 as shown in FIG. 10. The reference palatal anchorage device models shown in FIG. 9 have both forward and backward tilt angles of O, but with a difference in the upward tilt angle θ1, and the reference palatal anchorage device models shown in FIG. 10 have both upward and downward tilt angles of 0, but with a difference in the forward and downward tilt angle θ2, but the aspects are not limited thereto. Alternatively, the stored reference palatal anchorage device models may include previously stored, reference palatal anchorage device models for each hook part angle, which have predetermined upward and downward tilt angles θ1 and predetermined forward and backward tilt angles θ2.

Furthermore, although not shown, the system may be configured to store a plurality of reference palatal anchorage device models by length of the hook part 120, in addition to by angle of the hook part 120 relative to the body 110. In other words, in some aspects, a plurality of reference palatal anchorage device models may be stored and managed by angle and length of the hook part 120.

The modeling part 223 may include a model selection part 224 configured to receive palatal information including a palatal side-to-side flexion and a palatal maxillary anteroposterior flexion from the scan image analysis part 221, and based on the palatal information, select a reference palatal anchorage device model that matches the palatal information from among the plurality of reference palatal anchorage device models stored in the reference model storage part 222, and a model modification part 225 configured to fine-tune and modify the upward and downward, and forward and backward tilt angles, and length of the hook part 120 to match the palatal information based on the palatal anchorage device model selected by the model selection part 224. In this case, the model modification part 225 may be configured to include an editing tool for editing the 3D model directly by a designer.

The model selection part 224 is configured to select a reference palatal anchorage device model that fits the patient's palatal information from among the previously designed reference palatal anchorage device models according to the patient's palatal information detected by analyzing the 3D maxillary image in the scan image analysis part 221. For example, the model selection part 224 may be configured to analyze patient fixture analysis information including the upward and downward, and forward and backward tilt information of the hook parts, the length of the hook parts, and the like, and select a reference palatal anchorage device model having the best approximation to the patient fixture analysis information among the plurality of reference palatal anchorage device models according to the patient's palatal information.

Once the reference palatal anchorage device model is selected, the model modifier 225 may fine-tune the size and shape of the selected reference palatal anchorage device model based on the patient fixture analysis information so as to complete modeling a patient-customized palatal anchorage device model.

In other words, the model modification part 225 may create a patient-customized palatal anchorage device model by modifying, that is, by adjusting the shape and size of the selected reference palatal anchorage device model to match the patient fixture analysis information.

As described above, by scanning a 3D maxillary arch image of the patient with the 3D oral scanner 210, selecting a reference palatal anchorage device model that fits the 3D maxillary arch image, and fine-tuning the size and shape of the selected reference palatal anchorage device model to fit the 3D maxillary arch image and generating a patient-specific palatal anchorage device model, more efficient modeling of the palatal anchorage device is enabled.

The resultant patient-specific palatal anchorage device model may be 3D printed and produced via the 3D printer 230, in which case a 3D printing material may include a medical grade synthetic resin or medical grade titanium. As such, the present disclosure allows for the selection and use of biocompatible materials, which not only provides a wide range of choices in terms of material variety, but also allows for a wide range of color choices, which provides an aesthetic appeal to the orthodontic appliance.

The present invention has been illustrated and described above in connection with preferred embodiments for illustrating the principles of the present invention, but the present invention is not limited to the constructions and operations as illustrated and described as such. Rather, it will be apparent to those skilled in the art that many changes and modifications can be made to the present invention without departing from the spirit and scope of the appended claims. Accordingly, all such suitable alterations, modifications and equivalents are to be considered as falling within the scope of the present invention.

1. A palatal anchorage device for orthodontic treatment with enhanced support, comprising:
a body having a form of a triangular truss;
screw fixation parts and formed on each of three vertex regions of the body, with through-holes formed therein to allow a screw to be placed in a palate; and
hook parts extending from both sides of the body and hooking and fixing an elastic body connected to a tooth fixture, wherein
the screw fixation parts include a front screw fixation part formed on a front vertex of the body, and a pair of rear screw fixation parts formed on both rear vertices of the body, the pair of rear screw fixation parts are symmetrically formed with respect to the front screw fixation part,
the hook parts are configured to extend from a side of the triangular truss form of the body, or specifically, extend on both sides from both vertices at a rear end of the body such that the front screw fixation part supports the pair of rear screw fixation parts so that the pair of rear screw fixation parts is not moved forward even when a force to move the pair of rear screw fixation parts forward is generated by a pulling force of the elastic body,
the body has a form of an isosceles triangle, wherein the isosceles triangle has a length of a base of the isosceles triangle less than a height,
a spacing between the pair of rear screw fixation parts is configured to be shorter than a shortest straight line distance from the pair of rear screw fixation parts to the front screw fixture,
the hook parts include a plurality of locking protrusions and spaced apart at predetermined intervals to be locked with the elastic body so that the elastic body is fixed in position, and the hook parts further include, at ends of the hook parts, round parts 125 rounded to prevent the elastic body from being caught at the ends of the hook parts when the elastic body is released from the hook protrusions and.

2. A method for producing the palatal anchorage device for orthodontic treatment according to claim 1, the method comprising:
scanning a dental arch of a patient's teeth with a 3D oral scanner and acquiring an image of the arch;
editing, by using a design device, a reference palatal anchorage device model based on the arch image and modeling a patient-customized palatal anchorage device model; and
printing the patient-customized palatal anchorage device model with a 3D printer and producing a patient-customized palatal anchorage device.
